(19) United States
(12) Patent Application Publication
(10) Pub. No.: US 2025/0361411 A1
(43) Pub. Date: Nov. 27, 2025

(54) SHELF-STABLE SELF-LEVELING DECORATIVE SURFACE COATINGS AND METHODS OF MAKING THE SAME

(71) Applicant: Robert Brodsky, Bonita Springs, FL (US)

(72) Inventor: Robert Brodsky, Bonita Springs, FL (US)

(21) Appl. No.: 18/886,631

(22) Filed: Sep. 16, 2024

Related U.S. Application Data
(60) Provisional application No. 63/650,210, filed on May 21, 2024.

(51) Int. Cl. C09D 7/45; B05D 1/30; B05D 1/40; C09D 7/61; C09D 7/80

(52) U.S. Cl. CPC C09D 7/45; B05D 1/30; B05D 1/40; C09D 7/61; C09D 7/80; B05D 2320/00; B05D 2601/20

(57) ABSTRACT

The present invention comprises a shelf-stable, self-leveling, decorative surface coating product that is durable and easy to apply. The product allows for direct application to floor surfaces without the need for applying the decorative elements onsite. In certain embodiments, the product comprises of a selected resin, at least two dispersing agents, and a decorative filler material. Resins may include epoxy resin, polyurethane resin, polyaspartic resin, polyurea resin, polyester resin, or methyl methacrylate resin. Dispersing agents may include modified polyurethane and solutions of modified urea. Filler materials may include aluminum trihydrate, colorants, polyethylene terephthalate and cured polyester resin. Production of the decorative surface coatings involves adding a first dispersing agent to a resin, high-speed mixing, addition of a second dispersing agent, high-speed mixing, addition of a filler material, and high-speed mixing, all at ambient temperature. The decorative surface coating product may be shelf-stable for more than two years.

### CROSS-REFERENCE TO RELATED APPLICATIONS

This application claims the benefit of priority of U.S. Provisional Pat. App. Ser. No. 63/650,210, the contents of which are incorporated herein by reference in their entirety.

### BACKGROUND OF INVENTION

The application of decorative surface coatings, particularly floor coatings, involves the mixing of a filler material containing decorative elements into a resin at a specified ratio, followed by pouring of the resin containing the filler onto the floor surface following surface preparation. This process is labor intensive, time consuming and creates a lot of dust, making cleanup a challenge. What is needed in the art to make the process more efficient and less messy is a product containing a resin, such as epoxy, with filler material pre-mixed into the resin so the person pouring the material onto the floor surface does not have to spend the time and energy it takes to mix the filler into the resin and clean up dust after application. Unfortunately, filler materials tend to settle out of the resin over time and must then be resuspended by mixing prior to application, and resins tend to gain viscosity or harden over time, rendering them useless.

Currently, no shelf-stable product is available wherein filler material remains in uniform suspension in resin for application to a floor or other horizontal surface. It is an object of the invention described herein to solve this problem using a process that allows for the pre-mixing of filler containing decorative elements into a selected resin in a way that allows the decorative elements to remain in uniform suspension for a period of time that allows the product to be stocked by wholesalers and retailers in the marketplace for purchase by flooring companies, contractors or homeowners that engage in the application of the product to floors or other horizontal surfaces. A user of such a product then need only mix a catalyst into the product so the resin cures following application, pour the product onto a prepared horizontal surface, spread the product across the surface using a squeegee or similar device familiar to those of ordinary skill in the art, and then use a spiked roller or equivalent device to remove trapped air bubbles or gases to smooth out the product-coated surface prior to curing. The invention of the present disclosure addresses this long felt need in the art.

### BRIEF SUMMARY OF THE INVENTION

The present invention comprises a process and product made thereby that overcomes the problem of filler materials, particularly those containing decorative elements, settling out of resins before flooring applicators have a chance to pour the product on a floor surface. It is an object of the present invention to produce a shelf-stable resin-filler mixture containing decorative elements that can be stocked for a reasonable period of time and made available to purchasers during that time, eliminating the need for labor intensive pre-mixing on the application site.

Processes as described herein involve the addition of at least two dispersing agents to keep filler material containing decorative elements in suspension in a selected resin, meeting a long felt need in the art for a shelf stable floor coating product that can be poured directly on a floor or other horizontal surface of interest without mixing filler into the resin on site. A product made according to a process as described herein represents a technical advancement that allows technicians in the flooring industry in particular to purchase a resin and filler mixture wherein the filler contains decorative elements that remain in uniform suspension within the resin for direct application to floor surfaces without the need to take the separate step of mixing the filler into the resin at the job site, which is inefficient, labor intensive and messy.

The present invention also eliminates the need for broadcasting color flakes or color quartz, for example, into a resin solution during application, a method used as an alternative to mixing before pouring. Traditional systems may or may not involve mixing filler with resin on site, but they often require broadcasting these decorative elements separately. Broadcasting color flakes or quartz, for example, for aesthetics, has drawbacks. For example, some of the broadcasted material may not adhere to the resin and need to be scraped and removed before applying a topcoat, adding an extra cleaning step and increasing waste. This may also lead to a topcoat requirement, which is often required with traditional systems for optimal protection and aesthetics. It is yet another object of the present invention to eliminate such a topcoat requirement, which adds time and cost to the application cost for decorative floorings in particular.

The invention described herein addresses these challenges by incorporating decorative filler materials directly into a pre-mixed product composition in a way that keeps them uniformly dispersed in resin for significant periods of time. This eliminates the need for on-site pre-mixing, broadcasting, scraping and top coating, thereby simplifying the application process, making it more efficient, and reducing waste. While topcoats may be used for added protection of a floor coating as described herein, they are not mandatory for functionality or aesthetics. This present invention offers applicators greater flexibility and makes application more efficient, resulting in cost-savings and greater productivity in the field of decorative flooring, as well as other suitable applications, such as countertop coating, bar coating, table coating, desk coating, etc.

### BRIEF DESCRIPTION OF THE DRAWINGS

FIG. 1 illustrates a process flow according to an embodiment of the present invention for making a decorative surface coating product as described herein.

FIG. 2 illustrates the step of pouring a hardening catalyst into a decorative surface coating product as described herein.

FIG. 3 illustrates the step of mixing a hardening catalyst into a decorative surface coating product as described herein.

FIG. 4 illustrates the step of pouring a decorative surface coating product as described herein onto a flooring surface after a hardening catalyst is mixed in.

FIG. 5 illustrates the use of a squeegee to spread out a decorative surface coating product as described herein onto a floor surface following the step illustrated in FIG. 4.

FIG. 6 illustrates the step of rolling out a decorative surface coating product applied to a floor surface according to FIG. 5 using a spiked roller to remove air bubbles, gases and the like and smooth out the surface.

### DETAILED DESCRIPTION OF THE INVENTION

The invention of the present disclosure comprises a process for generating a one-coat, self-leveling, decorative surface coating product ideal for residential, commercial and industrial applications. While flooring is the primary application for a decorative surface coating product as described herein, application to any compatible horizontal surface is possible. A product made according to a process as described herein offers superior durability, aesthetics, and ease of application compared to traditional decorative surface coatings and is particularly ideal for the decorative coating of floor surfaces wherein a selected resin comprises decorative elements that tend to settle out of the selected resin over time and require mixing or broadcasting into the selected resin on the job site. While epoxy resin is desirable for utilization in a process according to the present disclosure, a wide variety of resins may be considered, e.g., polyurethane, polyaspartic, polyurea, polyester and MMA (methyl methacrylate) resins.

A process as described herein involves incorporation of filler material containing insoluble decorative elements into a selected resin containing at least two dispersing agents pre-mixed into the resin. In certain embodiments, a filler material may comprise aluminum trihydrate, colorants, polyethylene terephthalate, cured polyester resins or combinations thereof.

A selected filler material is kept in uniform suspension for long periods of time via the addition of dispersing agents, preferably at least two dispersing agents, which enhance the interaction between resin and filler particles, promoting uniform distribution. Selected dispersing agents also provide steric or electrostatic hindrance to prevent filler particles from aggregating and settling out of resin over time, which is one object of the present invention.

A product prepared according to a process as described herein is resistant to scratches, stains and chemicals, offering excellent durability comparable to or better than existing systems, all while eliminating the need for the mixing of filler material into resin on the job site. Once applied and cured, the coated surface has a high-gloss finish that is visually appealing. Products made according to the present disclosure may be tailored to include a variety of color options and decorative features, allowing for customization to suit a wide variety of styles. The resulting surface is easy to clean and maintain, reducing long-term maintenance costs. Fillers may comprise calcium carbonate, color quartz, aluminum trihydrate, cured polyester resin, colorants, polyethylene terephthalate and other filler types, and combinations thereof, as will be familiar to one of ordinary skill in the art.

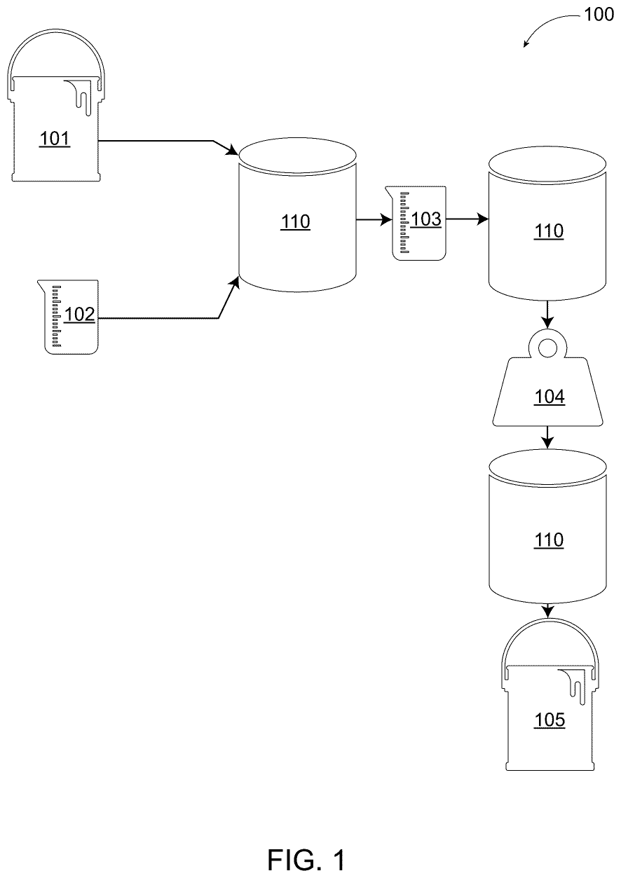

To illustrate a process flow 100 according to an embodiment of the present invention, FIG. 1 is provided. A resin 101 and a first dispersing agent 102 are added to a high-speed dispersion mixer 110. Mixing takes place at ambient temperature, which one of ordinary skill in the art will understand to mean 60-80° Fahrenheit, minor variations above or below that range may still be considered ambient for the purposes of this disclosure. Generally, resins and dispersing agents used in a process according to the present disclosure will include instructions that provide for suitable temperature ranges, which should be considered “ambient” for the purposes of this disclosure. Similarly, a first dispersing agent 102 is typically added to the resin 101 at a volume of about one percent of that of the resin 101, but again, a selected dispersing agent will include instructions advising on addition rates, so minor variations are considered to fall within the metes and bounds of this disclosure.

Mixing typically takes place for at least five minutes at no less than 1,000 revolutions per minute (rpm), and ideally no more than 2,500 rpm. The desired rpm will be selected depending on the mixer 110 used, and will typically be dictated by equipment size and capability, and the interest of the manufacturer in not mixing at such a high speed as to make a mess in the manufacturing site, as will be understood by one of ordinary skill in the art. Similarly, mixing times above five minutes are considered within the limitations of the invention of the present disclosure, but are not likely to exceed what is reasonably practicable from a manufacturing standpoint.

After the selected resin 101 and first dispersing agent 102 are completely mixed, a second dispersing agent 103 may be added to the mixer 110. While FIG. 1 shows two mixers 110, these are one and the same. The mixer 110 is shown as “two” mixers merely for ease of illustration of the addition of the second dispersing agent 103 to the mixer 110 containing the mixture of the resin 101 and first dispersing agent 102. The second dispersing agent 103 is typically added to the resin 101 at a volume of about three percent of that of the resin 101, but again, a selected dispersing agent will include instructions advising on addition rates, so minor variations are considered to fall within the metes and bounds of this disclosure.

After addition of the second dispersing agent 103, mixing again takes place for at least five minutes at no less than 1,000 rpm, and ideally no more than 2,500 rpm. The desired rpm will again be selected depending on the mixer 110 used, and will typically be dictated by equipment size and capability, and the interest of the manufacturer in not mixing at such a high speed as to make a mess in the manufacturing site, as will be understood by one of ordinary skill in the art. Similarly, mixing times above five minutes are considered within the limitations of the invention of the present disclosure, but are not likely to exceed what is reasonably practicable from a manufacturing standpoint.

After the second dispersing agent 103 has been completely mixed into the mixture of resin 101 and first dispersing agent 102, a filler 104 is added. An amount of filler 104 is typically added in order to achieve a ration of approximately 2:1 resin 101 to filler 104 by weight. The weight of filler added may deviate+/−10% of the weight that would achieve the ideal 2:1 ration of resin 101 to filler 104.

Once the filler 104 is added to the high-speed dispersion mixer 110, mixing takes place for least ten minutes at no less than 1,000 rpm, and ideally no more than 2,500 rpm. The desired rpm will again be selected depending on the mixer 110 used, and will typically be dictated by equipment size and capability, and the interest of the manufacturer in not mixing at such a high speed as to make a mess in the manufacturing site, as will be understood by one of ordinary skill in the art. Similarly, mixing times above ten minutes are considered within the limitations of the invention of the present disclosure, but are not likely to exceed what is reasonably practicable from a manufacturing standpoint. Unlike the dispersing agents, filler 104 is a powder or other solid material that requires longer mixing times to get into uniform suspension, hence the higher minimum mixing time. Once the filler 104 is completely mixed in, the result is the decorative surface coating product 105 that is the centerpiece of the present disclosure. The decorative surface coating product 105 can then be packaged, labeled, shipped, stored and sold for use in the field.

An exemplary process according to the present disclosure begins by determining a desired volume of a selected resin 101, then mixing the selected resin 101 with a first dispersing agent 102 comprising a solution of modified polyurethane. Typical properties of said solution of modified polyurethane may comprise an amine value of 12.5 mg of potassium hydroxide, a density of 1.05 grams per milliliter at 20 degrees Celsius, 52% non-volatile matter (20 minutes, 150 degrees Celsius), a solvent ration of 2:1 methoxypropylacetate to btylacetate, and a flash point of 35 degrees Celsius. Similarly, in certain embodiments, the second dispersing agent 103 comprises a solution of modified urea. Typical properties of said second dispersing agent may comprise 52% of an active substance, a density of about 1.13 grams per milliliter, N-Methylpyrrolidon as a solvent, and a flash point of 91 degrees Celsius. However, one of ordinary skill in the art will recognize that dispersing agents may include modified polyurethanes, modified ureas, hindered amine light stabilizers (HALs) and polyisobutenyl succinimides (PIBS). Specific choices of dispersing agents and orders of addition to resin 101 will depend on compatibility with a selected resin and desired performance characteristics.

Ideal properties of a filler 104 included in a decorative surface coating product 105 according to the present disclosure include colorants and other decorative elements. In certain embodiments, the filler 104 may comprise aluminum trihydrate, colorants, polyethylene terephthalate and cured polyester resin. Other filler materials may include quartz, calcium carbonate, or similar composite materials as will be known to one of ordinary skill in the art. Exemplary concentrations of said ingredients may be, for example, 60-99% aluminum trihydrate, less than 2.0% colorants, 0-50% polyethylene terephthalate and 0-30% cured polyester resin.

A decorative surface coating product 105 made by a process 100 as described herein stays in suspension at least 24 hours greater than controls lacking dispersing agents. It is a key object of the invention that such a decorative surface coating product 105 has a longer shelf life than any similar product on the market and eliminates the need for mixing filler materials into resins on site or broadcasting filler materials into resins applied to horizontal surfaces. Applicant has tested embodiments of decorative surface coating products 105 made according to a process 100 as described herein and observed the products 105 may have shelf lives of up to one week greater than controls; up to one month greater than controls; up to six months greater than controls; up to one year greater than controls; and up to or greater than two years greater than controls. These and other benefits of the present invention will be apparent to those of ordinary skill in the art in the field of floor coatings.

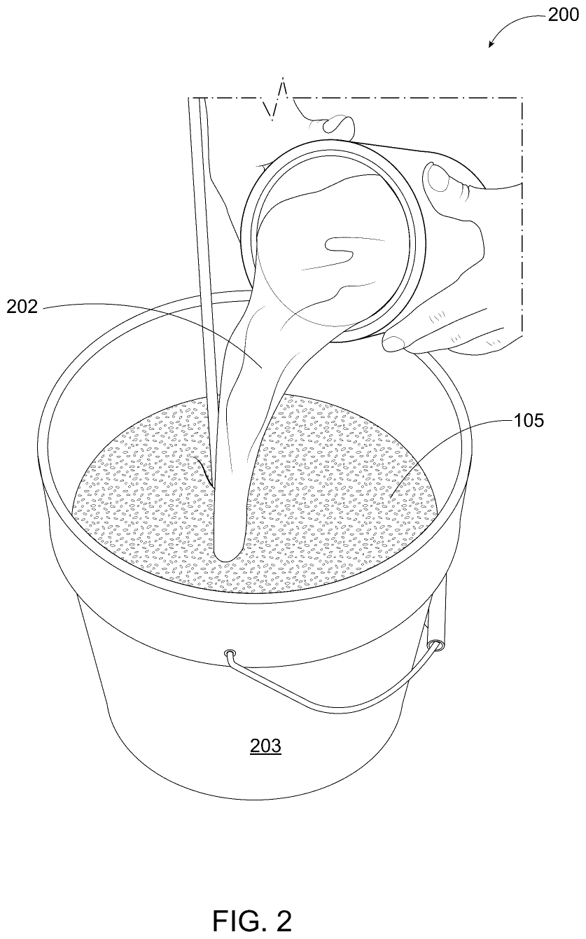

Once a decorative surface coating product 105 according to the present disclosure is packaged and sold, a purchaser or user of the decorative surface coating product 105 may begin the application process as illustrated in FIG. 2. The first step of the application process 200 is the addition of a hardening catalyst 202 to the decorative surface coating product 105. One of ordinary skill in the art will understand that the resins recited herein all require the addition of a hardening catalyst 202 so that a selected resin may cure and harden, becoming smooth and durable following application and curing. It is anticipated by the applicant that an appropriate hardening catalyst 202 will be sold with a decorative surface coating product 105 as described herein, and the selected catalyst will depend on compatibility with the selected resin. Most likely, the decorative surface coating product 105 will be sold in sealed packages 203, with catalysts packaged therewith, depending on what the market prefers.

One of ordinary skill in the art will understand that a hardening catalyst 202 may be selected from the group consisting of aliphatic, cycloaliphatic and aromatic amines (for epoxy, polyurethane, polyurea resins); organotin catalysts (polyurethane, polyurea resins); isocyanate (polyaspartic resins); methyl ethyl ketone (polyester resins) and 50% dibenzoyl peroxide (MMA (methyl methacrylate) resins).

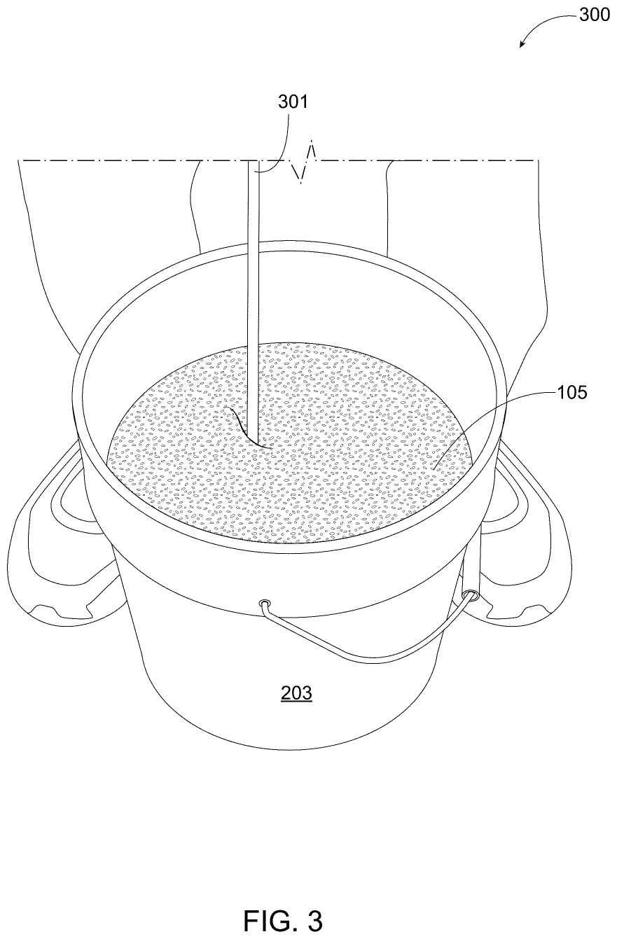

The second step 300 in the application process for a decorative surface coating decorative surface coating product 105 according to the present disclosure is to mix the hardening catalyst 202 using a suitable mixing implement 301, such as a mixing paddle attached to a drill, as shown in FIG. 3. Mixing times and speeds may vary depending on the volume of decorative surface coating product 105 and equipment used. These parameters may be selected by a technician trained in the application of floor coatings.

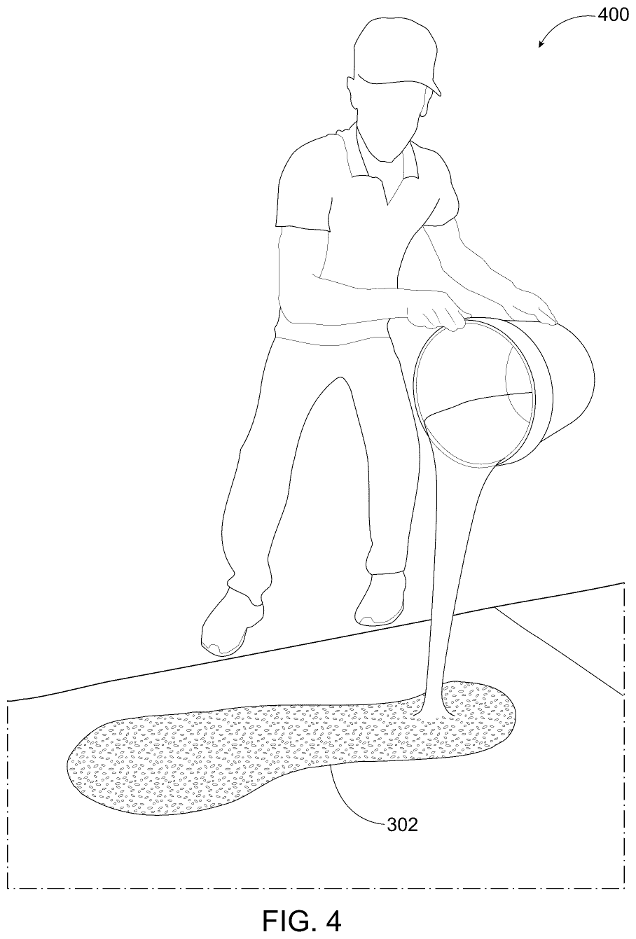

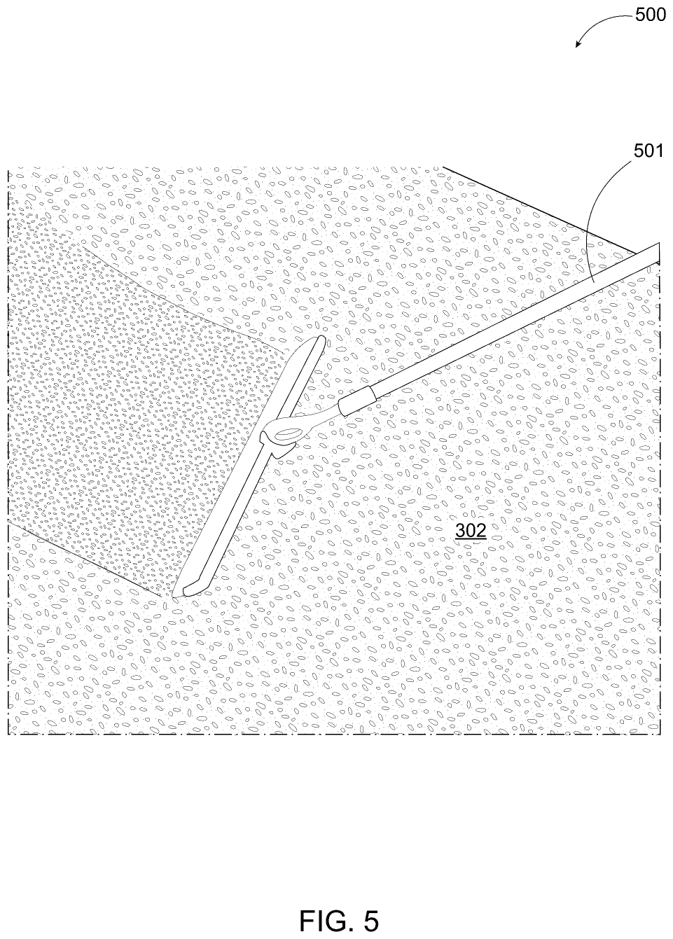

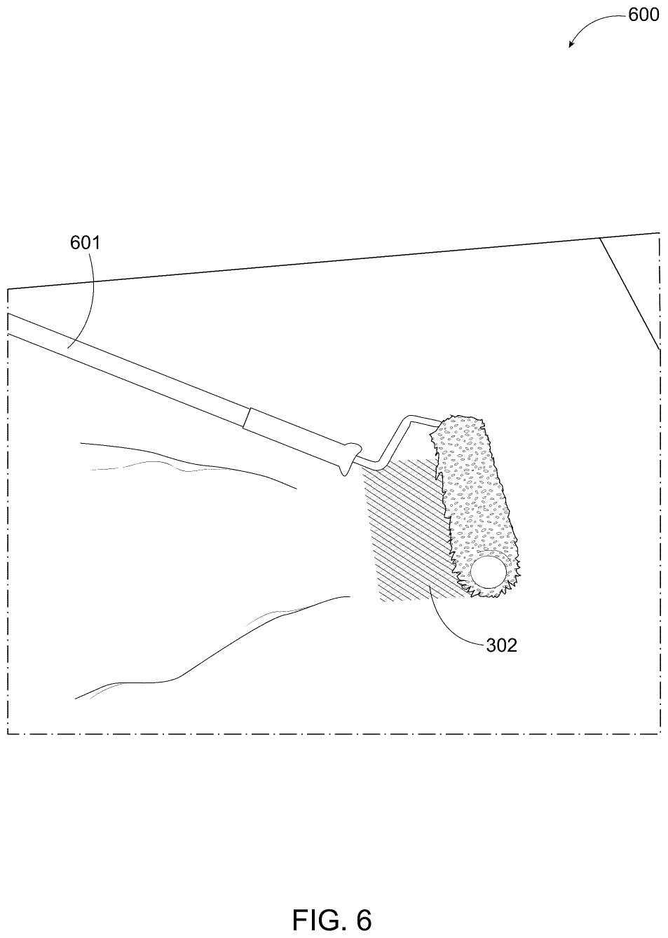

The third step 400 in the application process for a decorative surface coating product 105 according to the present disclosure is to pour the catalyst-product mixture 302 onto the surface to be coated, as shown in FIG. 4. While the primary application for the catalyst-product mixture 302 described herein is floor coating, one of ordinary skill in the art will appreciate that the catalyst-product mixture 302 may be used to coat any suitable horizontal surface, such as countertops, tabletops, desktops, bars, etc. Once the catalyst-product mixture 302 is poured onto the target surface, the fourth step 500 of the application process is to evenly spread the mixture across the surface using a squeegee or equivalent implement 501. Once the catalyst-product mixture 302 is evenly spread according to FIG. 5, a spiked roller or equivalent implement 601 is used to remove air bubbles and gasses that may be trapped in the catalyst-product mixture 302 as shown in FIG. 6. This is the final step 600 in the application process for a decorative surface coating product 105 (catalyst-product mixture 302) as described herein. After this step, the coated surface need only cure for an appropriate period of time at an appropriate temperature to permanently harden and be ready for use.

In a preferred embodiment, a decorative surface coating product 105 prepared according to the present disclosure comprises an epoxy resin which forms a strong, rigid, plastic-like material once a hardening catalyst 202 is added. This is in contrast to paints, which use binders like acrylic, oil, or water-based binders which dry to form a film but are not as strong and rigid as cured epoxies. Like paints, a system according to the present invention may incorporate pigments, but an object of the present invention is achieving a clear, glossy finish containing decorative elements like metallic flakes or colored sands. Pigments used in epoxies and other resins are typically chosen for their compatibility with the resin system to avoid chemical reactions or discoloration. Dispersion challenges may be less significant due to the desired transparency and the use of larger decorative elements. Paints, on the other hand, rely heavily on pigments to provide color. Paint manufacturers need to carefully select pigments for compatibility with the binder and ensure proper dispersion to achieve even color distribution and opacity.

A product according to the present disclosure may incorporate fillers like aluminum trihydrate for some opacity or colored quartz for decorative effects. Fillers are often chosen for their aesthetic contribution or to modify the viscosity of the epoxy for pouring applications. Paints, on the other hand, often contain fillers like calcium carbonate or titanium dioxide to extend the paint volume, improve opacity, and influence texture. The selection and dispersion of fillers in paint are crucial for achieving desired application properties and hiding power.

The examples used in this disclosure are for illustrative purposes only and are not to be construed as limitations. Those of ordinary skill in the art will understand that there are many combinations of resins and decorative elements that may be dispersed according to the present disclosure and made shelf stable according to the processes described herein. Minor variations in percentages of components in a final product, catalysts and volumes used, dispersion mixers and other tools used in the manufacture and application of a product as described herein are to be expected based on the application and environment. The benefits of a shelf stable decorative coating product for application to floors and other suitable horizontal surfaces will be evident to those of ordinary skill in the art.

What is claimed:

1. A process for making a decorative surface coating product, the process comprising:
adding a predetermined percentage by volume of a first dispersing agent to a volume of a resin in a high-speed dispersion mixer;
mixing the first dispersing agent with the resin in the high-speed dispersion mixer for at least five minutes at a speed of at least 1,000 revolutions per minute at ambient temperature to produce a first mixture;
adding a predetermined percentage by volume of a second dispersing agent to the first mixture in the high-speed dispersion mixer;
mixing the second dispersing agent with the first mixture in the high-speed dispersion mixer for at least five minutes at a speed of at least 1,000 revolutions per minute at ambient temperature to produce a second mixture;
adding a filler to the second mixture in the high-speed dispersion mixer;
mixing the filler with the second mixture in the high-speed dispersion mixer for at least ten minutes at a speed of at least 1,000 revolutions per minute at ambient temperature to produce the decorative surface coating product; and
packaging the decorative surface coating product.

2. The process of claim 1, wherein the resin is selected from the group consisting of epoxy resins, polyurethane resins, polyaspartic resins, polyurea resins, polyester resins, MMA (methyl methacrylate) resins, and combinations thereof.

3. The process of claim 1, wherein the dispersing agents are selected from the group consisting of solutions of modified polyurethane, solutions of modified urea, hindered amine light stabilizers, polyisobuylene succinimides and combinations thereof.

4. The process of claim 1, wherein the first dispersing agent is a solution of modified polyurethane and the second dispersing agent is a solution of modified urea.

5. The process of claim 4, wherein:
the solution of modified polyurethane has an amine value of 12.5 mg of potassium hydroxide, a density of 1.05 grams per milliliter at 20 degrees Celsius, 52% non-volatile matter (20 minutes, 150 degrees Celsius), a solvent ration of 2:1 methoxypropylacetate to btylacetate, and a flash point of 35° Celsius; and
the solution of modified urea comprises 52% of an active substance, a density of about 1.13 grams per milliliter, N-Methylpyrrolidon as a solvent, and a flash point of 91 degrees Celsius.

6. The process of claim 1, wherein the filler is selected from the group consisting of aluminum trihydrate, colorants, polyethylene terephthalate, cured polyester resins, quartz, calcium carbonate, similar composite materials, and combinations thereof.

7. The process of claim 6, wherein the filler comprises a carrier particle and a layered silicate, wherein the carrier particle is charged with a coating composition.

8. A decorative surface coating product made according to the process of claim 1.

9. The decorative surface coating product of claim 8, wherein the resin is selected from the group consisting of epoxy resins, polyurethane resins, polyaspartic resins, polyurea resins, polyester resins, MMA (methyl methacrylate) resins, and combinations thereof.

10. The decorative surface coating product of claim 8, wherein the dispersing agents are selected from the group consisting of solutions of modified polyurethane, solutions of modified urea, hindered amine light stabilizers, polyisobuylene succinimides and combinations thereof.

11. The decorative surface coating product of claim 8, wherein the first dispersing agent is a solution of modified polyurethane and the second dispersing agent is a solution of modified urea.

12. The decorative surface coating product of claim 11, wherein:
the solution of modified polyurethane has an amine value of 12.5 mg of potassium hydroxide, a density of 1.05 grams per milliliter at 20 degrees Celsius, 52% non-volatile matter (20 minutes, 150 degrees Celsius), a solvent ration of 2:1 methoxypropylacetate to btylacetate, and a flash point of 35° Celsius; and
the solution of modified urea comprises 52% of an active substance, a density of about 1.13 grams per milliliter, N-Methylpyrrolidon as a solvent, and a flash point of 91 degrees Celsius.

13. The decorative surface coating product of claim 8, wherein the filler is selected from the group consisting of aluminum trihydrate, colorants, polyethylene terephthalate, cured polyester resins, quartz, calcium carbonate, similar composite materials, and combinations thereof.

14. The decorative surface coating product of claim 8, wherein the filler material remains in uniform suspension for greater than six months at ambient temperature.

15. The decorative surface coating product of claim 8, wherein the filler material remains in uniform suspension for greater than one year at ambient temperature.

16. The decorative surface coating product of claim 8, wherein the filler material remains in uniform suspension for greater than two years at ambient temperature.

17. A process for coating a horizontal surface, the process consisting essentially of:
preparing the horizontal surface for coating;
mixing a hardening catalyst into the decorative surface coating product of claim 8 to produce a catalyst-product mixture;
pouring the catalyst-product mixture onto the horizontal surface;
spreading the catalyst-product mixture evenly across the horizontal surface;
removing any air bubbles and gases from the catalyst-product mixture; and
allowing the catalyst-product mixture to cure, wherein the catalyst-product mixture is completely hardened thereafter.

18. The process of claim 15, wherein the catalyst-product mixture is self-leveling.
